(19) United States
(12) Patent Application Publication
(10) Pub. No.: US 2022/0170775 A1
(43) Pub. Date: Jun. 2, 2022

(54) DEVICE FOR CAPACITIVE MEASUREMENT OF A HEIGHT OF A FLUID IN A TANK

(71) Applicant: KAPFLEX, Meylan (FR)

(72) Inventors: Pierre Thibault, Saint Martin d'Uriage (FR); Alexandre Delorme, Saint-Ismier (FR); Alix Duclos, Voiron (FR)

(21) Appl. No.: 17/614,300

(22) PCT Filed: May 25, 2020
(86) PCT No.: PCT/FR2020/050870

§ 371 Date: Nov. 24, 2021

(30) Foreign Application Priority Data
May 27, 2019 (FR) FR1905560

(51) Int. Cl. G01F 23/263

(52) U.S. Cl. CPC G01F 23/266; G01F 23/268

(57) ABSTRACT

A device, for capacitive measurement of a height of a fluid in a tank, comprises at least one pair of capacitors extending in a longitudinal direction. A first capacitor forms first geometric patterns defining a first line capacitance. A second capacitor is opposite the first capacitor and forms second geometric patterns defining a second line capacitance. The first and second geometric patterns are arranged so that the first and second line capacitances, integrated in the longitudinal direction, have a sum that depends on the position of the fluid in the longitudinal direction. The first and second line capacitances, integrated in the longitudinal direction, have a difference that is a constant for reference positions of the fluid in the longitudinal direction.

### CROSS-REFERENCE TO RELATED APPLICATIONS

This application is a national phase entry under 35 U.S.C. § 371 of International Patent Application PCT/FR2020/050870, filed May 25, 2020, designating the United States of America and published as International Patent Publication WO 2020/240127 A1 on Dec. 3, 2020, which claims the benefit under Article 8 of the Patent Cooperation Treaty to French Patent Application Serial No. FR1905560, filed May 27, 2019.

### TECHNICAL FIELD

The disclosure relates to the technical field of devices for taking capacitive measurements of a height of fluid in a tank. More precisely, the disclosure relates to what may be called compensating devices, i.e., devices allowing the height of a fluid to be measured without knowing the relative permittivity of the fluid with precision.

The disclosure is, in particular, applicable to the measurement of a height of fluid in a mobile tank belonging to a mobile means of transport (e.g., motor vehicle, aircraft, boat) or in a fixed tank used in an industrial process.

### BACKGROUND

Measurement of a height of fluid in a tank is important in terms of safety and from the economic point of view, for example, in order to avoid running out of fuel or to anticipate the need to replenish the tank in the context of implementation of an industrial process.

One device known in the art, in particular from document WO 99/10714 (referred to herein as “D1”), is a device for taking capacitive measurements of a height of a fluid in a tank, the fluid possessing a free surface, the device comprising a pair of capacitors extending in a longitudinal direction intended to be parallel to the normal to the free surface of the fluid, the pair of capacitors comprising:
a first capacitor, comprising a first pair of electrodes forming first geometric patterns defining a first linear electrical capacitance that varies in the longitudinal direction;
a second capacitor, opposite the first capacitor, and comprising a second pair of electrodes forming second geometric patterns defining a second linear electrical capacitance that varies in the longitudinal direction.

In D1 (page 14, line 3; page 15, line 16), the first and second geometric patterns are arranged so that the first and second linear electrical capacitances, integrated in the longitudinal direction, possess a ratio that depends on the position of the fluid in the longitudinal direction and that is independent of the dielectric constant of the fluid.

Such a device is not entirely satisfactory insofar as it does not allow the height of the fluid to be measured with precision when the tank is almost full or almost empty. Specifically, such configurations require an almost infinite measurement precision if reliable measurement compensation is to be obtained in the presence of small variations in the relative permittivity of the fluid.

### BRIEF SUMMARY

Embodiments of the disclosure aim to remedy all or some of the aforementioned drawbacks. To this end, one subject of the disclosure is a device for taking capacitive measurements of a height of a fluid in a tank, the fluid possessing a free surface, the device comprising at least one pair of capacitors extending in a longitudinal direction intended to be parallel to the normal to the free surface of the fluid, the or each pair of capacitors comprising:
a first capacitor, comprising a first pair of electrodes forming first geometric patterns defining a first linear electrical capacitance that varies in the longitudinal direction;
a second capacitor, opposite the first capacitor, and comprising a second pair of electrodes forming second geometric patterns defining a second linear electrical capacitance that varies in the longitudinal direction;
the device being noteworthy in that the first and second geometric patterns are arranged so that:
   the first and second linear electrical capacitances, integrated in the longitudinal direction, possess a sum that depends on the position of the fluid in the longitudinal direction;
   the first and second linear electrical capacitances, integrated in the longitudinal direction, possess a difference that is a constant for reference positions of the fluid in the longitudinal direction.

Thus, such a device according to the disclosure allows, by virtue of such an arrangement of the first and second geometric patterns, the precision of the measurement of the height of fluid when the tank is almost full or almost empty to be improved. Specifically, the combination of the information as to the sum and difference of the first and second linear electrical capacitances, integrated in the longitudinal direction, allows, if suitable reference positions are chosen, a better measurement precision to be obtained over the spatial extent of the tank (in the longitudinal direction), while preserving a compensating device that does not require the relative permittivity of the fluid to be known with precision. Furthermore, the sum and difference of the first and second linear electrical capacitances, integrated in the longitudinal direction, may be easily measured, for example via an electronic circuit comprising a two-channel measuring system, with a differential mode.

### Definitions

By “opposite,” what is meant is that the first and second capacitors face each other in a direction perpendicular to the longitudinal direction.

By “reference position of the fluid,” what is meant is a position of interest (that it is desired to identify) of the fluid in the tank in the longitudinal direction, corresponding to a position located on a pair of capacitors in the longitudinal direction. By way of nonlimiting examples, a position of interest may correspond to a fluid level indicating that the fuel tank reserve has been started, to a fluid level indicating that the tank is full or half full, etc. A reference position of the fluid may be geometrically predetermined, by arranging the first and second geometric patterns of the pair of capacitors so that the first and second linear electrical capacitances, integrated in the longitudinal direction, possess a difference that is a constant (and preferably zero) for a predetermined position in the longitudinal direction. The predetermined position defines the reference position.

By “constant,” what is meant is that the difference between the first and second linear electrical capacitances, integrated in the longitudinal direction, is independent of the position of the fluid in the longitudinal direction. In other words, the difference between the first and second linear electrical capacitances, integrated in the longitudinal direction, does not vary for the reference positions, whatever the position of the fluid in the tank, and whether the fluid is present in or absent from the tank. The first and second geometric patterns are advantageously arranged so that the first and second linear electrical capacitances, integrated in the longitudinal direction, possess a difference that is zero for the reference positions of the fluid, whatever the position of the fluid in the tank, and whether the fluid is present in or absent from the tank. Thus, it is easier to design the first and second geometric patterns independently of the nature of the fluid.

The device, according to embodiments of the disclosure, may comprise one or more of the following features.

According to one feature of the disclosure, the or each pair of capacitors comprises a median axis extending in a direction perpendicular to the longitudinal direction.

According to one feature of the disclosure, the first geometric patterns are arranged on either side of the median axis so as to achieve an axial symmetry about the median axis; and the second geometric patterns are arranged on either side of the median axis so as to achieve an axial symmetry about the median axis.

Thus, one obtained advantage is that the first and second linear electrical capacitances, integrated in the longitudinal direction, possess a difference that is zero at:
a first reference position of the fluid corresponding to a median position in the longitudinal direction (i.e., a position on the median axis if the fluid makes contact with the device or a position parallel to the median axis if the fluid is at distance from the device),
a second reference position of the fluid corresponding to an upper distal position in the longitudinal direction. By “distal,” what is meant is the longitudinal position furthest from the center of the pair of capacitors. In the presence of a single pair of capacitors, the upper distal position corresponds to a fully filled tank.

According to one feature of the disclosure, the first geometric patterns and the second geometric patterns are arranged above the median axis so as to achieve a central symmetry; and the first geometric patterns and the second geometric patterns are arranged below the median axis so as to achieve a central symmetry.

Thus, one obtained advantage is that the first and second linear electrical capacitances, integrated in the longitudinal direction, possess a sum that is proportional to the position of the fluid in the longitudinal direction on either side of the median axis.

According to one feature of the disclosure, the first geometric patterns and the second geometric patterns are arranged above the median axis so that the first and second linear electrical capacitances, integrated above the median axis in the longitudinal direction, possess a difference that is a constant and preferably zero; and the first geometric patterns and the second geometric patterns are arranged below the median axis so that the first and second linear electrical capacitances, integrated below the median axis in the longitudinal direction, possess a difference that is a constant and preferably zero.

Thus, one obtained advantage is that the first and second linear electrical capacitances, integrated in the longitudinal direction, possess a difference that is constant (and possibly zero) at:
a first reference position of the fluid corresponding to a median position in the longitudinal direction (i.e., a position on the median axis if the fluid makes contact with the device or a position parallel to the median axis if the fluid is at distance from the device),
a second reference position of the fluid corresponding to an upper distal position in the longitudinal direction. By “distal,” what is meant is the longitudinal position furthest from the center of the pair of capacitors. In the presence of a single pair of capacitors, the upper distal position corresponds to a fully filled tank.

According to one feature of the disclosure, the first and second geometric patterns are arranged so that the first and second linear electrical capacitances, integrated in the longitudinal direction, possess a difference that changes sign on either side of the median axis.

Thus, one obtained advantage is the avoidance of ambiguities in the longitudinal position of the fluid with respect to the median axis.

According to one feature of the disclosure, the first and second geometric patterns are arranged so that the first and second linear electrical capacitances, integrated in the longitudinal direction, possess a difference of zero for at least two reference positions of the fluid in the longitudinal direction.

According to one feature of the disclosure, the first and second geometric patterns are arranged so that the first and second linear electrical capacitances, integrated in the longitudinal direction, possess a sum proportional to the position of the fluid in the longitudinal direction.

By “proportional,” what is meant is that there is a linear relationship between the sum of the first and second linear electrical capacitances, integrated in the longitudinal direction, and the position of the fluid in the longitudinal direction.

Thus, one obtained advantage is simplification of the obtainment of the measurement of the height of the fluid.

According to one feature of the disclosure, the first and second capacitors are capacitors with interdigitated electrodes.

Thus, one obtained advantage is the ability to determine the relative permittivity of the fluid.

According to one feature of the disclosure, the device comprises a set of pairs of capacitors, each pair of capacitors possessing a length in the longitudinal direction, the set of pairs of capacitors being distributed in the longitudinal direction so that their length follows a geometric series.

Thus, one obtained advantage is cumulation of:
continuous measurements for each given pair of capacitors;
discrete measurements between each pair of capacitors.

Distributing the set of pairs of capacitors in the longitudinal direction so that their length follows a geometric series allows, at equal electrical capacitance for each pair of capacitors, the precision of the measurement of the height of fluid in the longitudinal direction to be spatially modulated. As regards measurement of the height of fluid, the pairs of capacitors with the shortest lengths possess, locally, a better precision than the pairs of capacitors with the longest lengths. This type of configuration will possibly be chosen, for example, if the targeted application requires a better precision when the tank is almost empty, in order to predict the moment of replenishment.

According to one feature of the disclosure, the device comprises a set of pairs of capacitors distributed in the longitudinal direction periodically.

By “periodically,” what is meant is that the first and second geometric patterns repeat identically at regular spatial intervals in the longitudinal direction.

Thus, one obtained advantage is cumulation of:
continuous measurements for each given pair of capacitors;
discrete measurements between each pair of capacitors.

Furthermore, such a periodic distribution allows industrial production of the device to be facilitated, and different sizes of tank to be easily accommodated.

According to one feature of the disclosure, the device comprises a set of pairs of capacitors distributed in the longitudinal direction, the first and second geometric patterns of two adjacent pairs of capacitors being arranged so that:
the sum of the first and second linear electrical capacitances, integrated in the longitudinal direction, is a monotonic function in the longitudinal direction;
the difference between the first and second linear electrical capacitances, integrated in the longitudinal direction, is constant in the longitudinal direction, and preferably zero, for the reference positions of the fluid in the longitudinal direction.

Thus, one obtained advantage is cumulation of:
continuous measurements for each given pair of capacitors;
discrete measurements between each pair of capacitors.

Furthermore, it is made possible to spatially modulate the precision of measurement of the height of fluid in the longitudinal direction. The sensitivity of the pair of capacitors increases as the sum of the first and second linear electrical capacitances, integrated in the longitudinal direction, increases. This type of configuration will possibly be chosen, for example, if the targeted application requires a better precision when the tank is almost empty, in order to predict the moment of replenishment.

According to one feature of the disclosure, the device comprises a protective layer made of a dielectric, preferably a plastic, and arranged to cover the or each pair of capacitors.

Thus, one obtained advantage is to be able, in particular, to protect from the fluid the electronic part of the device.

According to one feature of the disclosure, the device comprises:
a printed circuit board,
electrically conductive tracks, arranged on the printed circuit board, and forming the or each pair of capacitors.

Thus, one obtained advantage is easy production of the device on the industrial scale.

Another subject of the disclosure is a tank comprising at least one device according to the disclosure, the or each pair of capacitors being arranged so as to generate an electric field inside the tank.

According to one feature of the disclosure, the tank contains a fluid, and comprises a side wall made of a dielectric, the device being arranged inside the side wall, at distance from the fluid.

Thus, one obtained advantage is avoidance of a direct contact, between the fluid and the device, liable to result in degradation. The device according to the disclosure remains functional and reliable insofar as it is not necessary to know, with precision, the relative permittivity of the medium comprising the side wall and the fluid. Furthermore, the device is mechanically protected from the exterior environment by virtue of the side wall.

According to one feature of the disclosure, the tank comprises a heating device, arranged in the tank to heat the fluid, the heating device comprising a metal portion forming a ground, the or each pair of capacitors being electrically connected to the ground.

Thus, one obtained advantage is simplification of grounding the device.

According to one feature of the disclosure, the device is arranged at a distance from the fluid comprised between 0.05 mm and 25 mm, and preferably comprised between 4 mm and 6 mm.

Thus, one obtained advantage is to preserve a satisfactory precision in the measurement of fluid height.

### BRIEF DESCRIPTION OF THE DRAWINGS

Other features and advantages will become apparent from the detailed description of various embodiments of the disclosure, the description being accompanied by examples and references to the accompanying drawings.

FIG. 1 is a partial schematic view, in exploded perspective, of a device according to the disclosure, illustrating a first mode of integration of the device into a wall of a tank.

FIG. 2 is a partial schematic view, in exploded perspective, of a device according to the disclosure, illustrating a second mode of integration of the device into a wall of a tank.

FIG. 3 is a schematic view in perspective of a tank equipped with a device according to the disclosure.

FIG. 4 is a schematic view in longitudinal cross section of a first embodiment of a set of pairs of capacitors of a device according to the disclosure.

FIG. 5 is a schematic view in longitudinal cross section of a second embodiment of a set of pairs of capacitors of a device according to the disclosure.

FIG. 6 is a schematic view in longitudinal cross section, on an enlarged scale, of a pair of capacitors according to the first embodiment illustrated in FIG. 4.

FIG. 7 is a schematic view in longitudinal cross section, on an enlarged scale, of a pair of capacitors according to the second embodiment illustrated in FIG. 5.

FIG. 8 is a schematic view, in longitudinal cross section, of a set of pairs of capacitors distributed in the longitudinal direction periodically.

FIG. 9 is a schematic view, in longitudinal cross section, of a set of pairs of capacitors distributed in the longitudinal direction so that their length follows a geometric series.

FIG. 10 is a schematic view, in longitudinal cross section, of a set of pairs of capacitors the sum of the first and second linear electrical capacitances of which, integrated in the longitudinal direction, is a monotonic function in the longitudinal direction; the set of pairs of capacitors is arranged on either side of a separator.

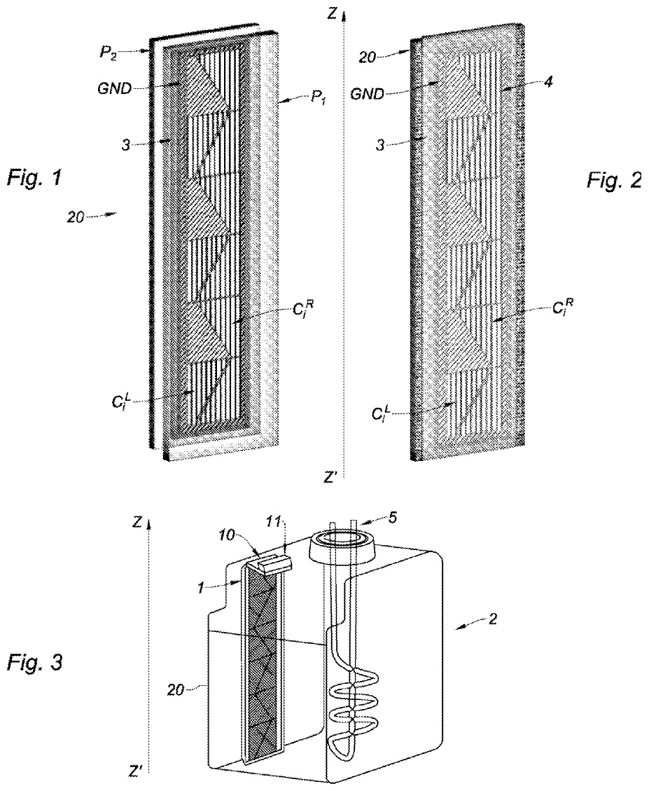

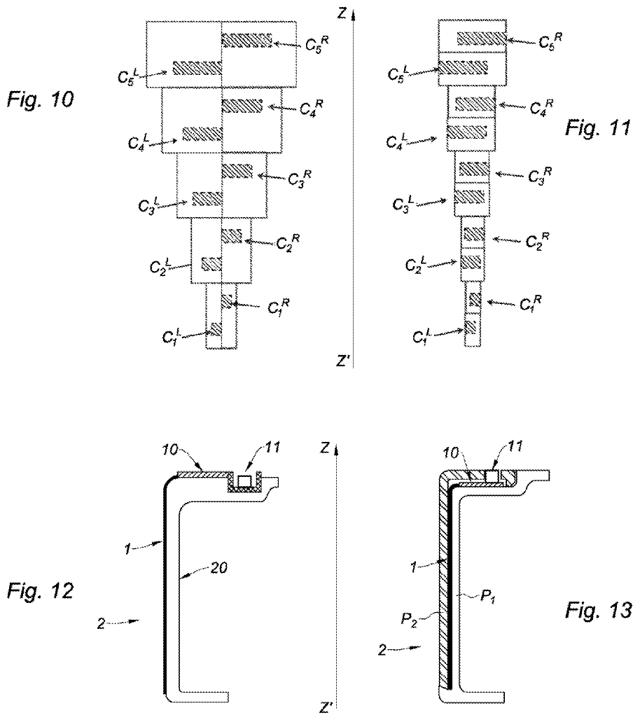

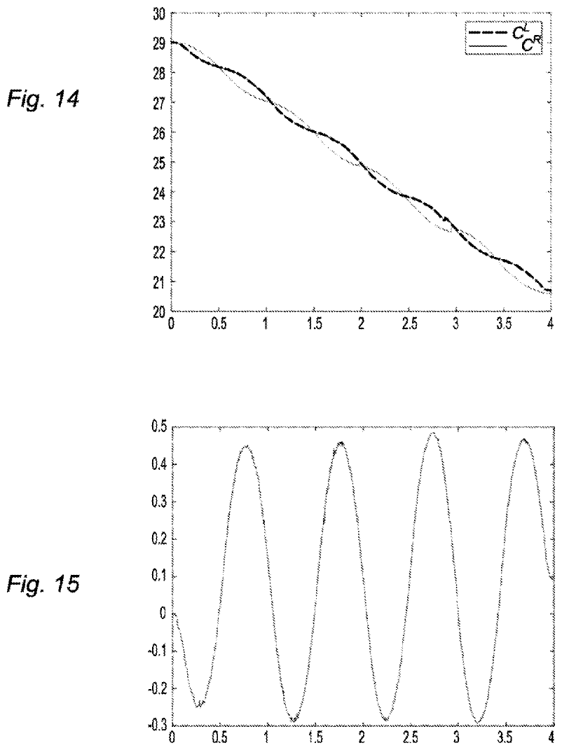

FIG. 1 is a view analogous to FIG. 10, in the absence of a separator.

FIG. 12 is a partial schematic view in cross section of a wall of a tank, illustrating a first mode of integration of the device according to the disclosure.

FIG. 13 is a partial schematic view in cross section of a wall of a tank, illustrating a second mode of integration of the device according to the disclosure.

FIG. 14 is a graph showing on the x-axis the number of periods of a set of pairs of capacitors, and on the y-axis the electrical capacitance (in pF) for the left-hand capacitors (C^{L}) and for the right-hand capacitors (C^{R}).

FIG. 15 is a graph representing on the x-axis the number of periods of a set of pairs of capacitors, and on the y-axis the difference in electrical capacitance (in pF) between the left-hand capacitors and the right-hand capacitors.

### DETAILED DESCRIPTION

For the sake of simplicity, elements that are identical or that perform the same function have been designated with the same references in the various embodiments.

One subject of the disclosure is a device 1 for taking capacitive measurements of a height of a fluid in a tank 2, the fluid possessing a free surface, the device 1 comprising at least one pair of capacitors Cᵢ^{L}, Cᵢ^{R} extending in a longitudinal direction Z′-Z intended to be parallel to the normal to the free surface of the fluid, the or each pair of capacitors Cᵢ^{L}, Cᵢ^{R} comprising:
a first capacitor Cᵢ^{L} (i corresponding to the i-th pair) comprising a first pair of electrodes forming first geometric patterns Cᵢ^{LB}, Cᵢ^{LT} defining a first linear electrical capacitance that varies in the longitudinal direction Z′-Z;
a second capacitor Cᵢ^{R} (i corresponding to the i-th pair), opposite to the first capacitor Cᵢ^{L}, and comprising a second pair of electrodes forming second geometric patterns Cᵢ^{RB}, Cᵢ^{RT} defining a second linear electrical capacitance that varies in the longitudinal direction Z′-Z.

The first and second geometric patterns Cᵢ^{LB}, Cᵢ^{LT}; Cᵢ^{RB}, Cᵢ^{RT} are arranged so that:
the first and second linear electrical capacitances, integrated in the longitudinal direction Z′-Z, possess a sum (denoted Sᵢ, i corresponding to the i-th pair) that depends on the position of the fluid in the longitudinal direction Z′-Z;
the first and second linear electrical capacitances, integrated in the longitudinal direction Z′-Z, possess a difference (denoted Dᵢ, i corresponding to the i-th pair) that is a constant (denoted K) for reference positions of the fluid in the longitudinal direction Z′-Z.

If the position of the fluid in the longitudinal direction Z′-Z is denoted z and the reference positions denoted z_{ref}, then:

Sᵢ(z)=Cᵢ^{LB}(z)+Cᵢ^{LT}(z)+Cᵢ^{RB}(z)+Cᵢ^{RT}(z)

Dᵢ(z)=Cᵢ^{LB}(z)+Cᵢ^{LT}(z)−Cᵢ^{RB}(z)−Cᵢ^{RT}(z)

Dᵢ(z_{ref})=K

### Pair(s) of Capacitors:

The or each pair of capacitors Cᵢ^{L}, Cᵢ^{R} advantageously comprises a median axis X′-X extending in a direction perpendicular to the longitudinal direction Z′-Z.

The first and second capacitors Cᵢ^{L}, Cᵢ^{R} are advantageously capacitors with interdigitated electrodes.

The device 1 advantageously comprises a set of pairs of capacitors Cᵢ^{L}, Cᵢ^{R}, each pair of capacitors Cᵢ^{L}, Cᵢ^{R} possessing a length (denoted L) in the longitudinal direction Z′-Z.

According to a first embodiment (illustrated in FIG. 9), the set of pairs of capacitors Cᵢ^{L}, Cᵢ^{R} is distributed in the longitudinal direction Z′-Z so that their length Lᵢ follows a geometric series:

Lᵢ=αⁱ⁻¹*δ; α>1; i∈[1;N]

where α is the common ratio of the geometric series, δ is the length of the first pair of capacitors Cᵢ^{L}, Cᵢ^{R}, N is the number of pairs of capacitors Cᵢ^{L}, Cᵢ^{R}, and i indicates the i-th pair of capacitors Cᵢ^{L}, Cᵢ^{R}. The pairs of capacitors with the shortest lengths (lower levels) possess, locally, a better precision as regards the measurement of the fluid height than the pairs of capacitors with the longer lengths (upper levels). This spatial modulation of measurement precision is useful both:
with respect to estimating with precision the level remaining in a tank 2, and
with respect to predicting with a good precision the date on which replenishment will be required, assuming the consumption of fluid is constant or predictable over time.

This has an economic advantage by virtue of a better management of replenishments, since, by extrapolation of the quantity (hᵢ₊₁−hᵢ)/(tᵢ₊₁−tᵢ), where hᵢ₊₁ and hᵢ, respectively, are the remaining heights of fluid at the times tᵢ₊₁ and tᵢ, respectively, it is possible—with less uncertainty than a method based on human experience alone—to determine the date on which the fluid in the tank 2 will run out. From a mathematical point of view, such measurement points allow a person having ordinary skill in the art to qualify models that he has been able to develop, and to update his predictions.

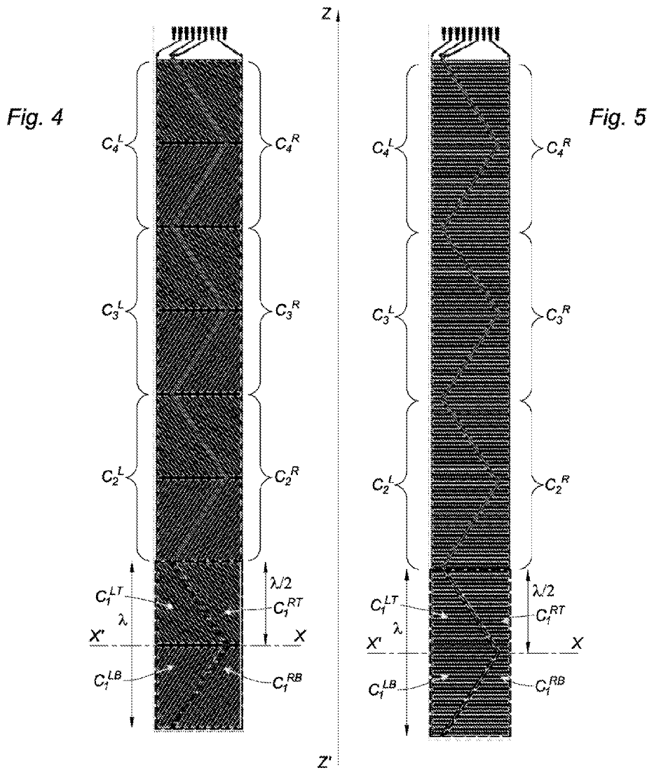

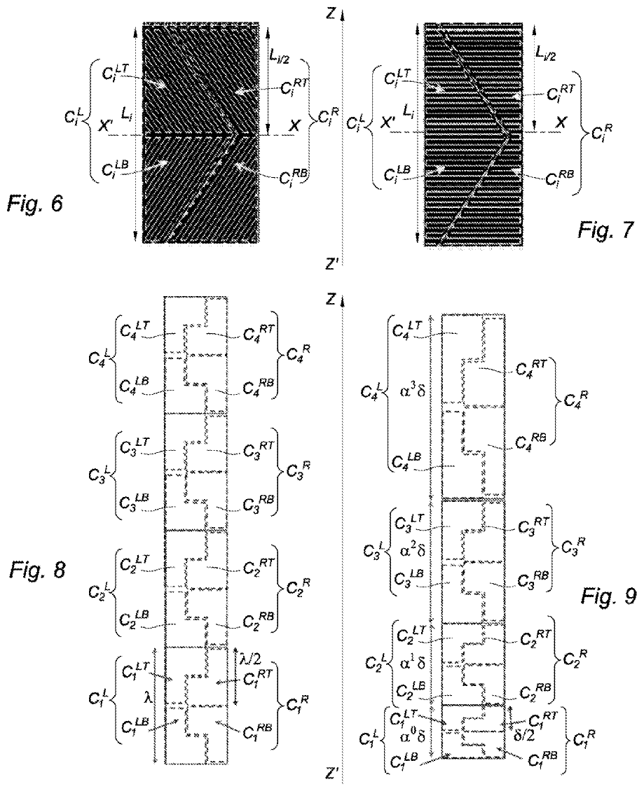

According to a second embodiment (in particular, illustrated in FIGS. 4, 5 and 8), the set of pairs of capacitors Cᵢ^{L}, Cᵢ^{R} is distributed in the longitudinal direction Z′-Z periodically. The length Lᵢ of each pair of capacitors Cᵢ^{L}, Cᵢ^{R} is therefore constant in the longitudinal direction Z′-Z.

Lᵢ=λ; i∈[1;N]

where λ is the spatial period of the pairs of capacitors Cᵢ^{L}, Cᵢ^{R}.

The device 1 advantageously comprises:
a printed circuit board 3,
electrically conductive tracks, arranged on the printed circuit board, and forming the or each pair of capacitors Cᵢ^{L}, Cᵢ^{R}.

The printed circuit board 3 may be made from a material chosen from polyimide, FR-4 epoxy resin, and cellulose paper. The electrically conductive tracks may be made from a material chosen from Cu, Al, graphite, and graphene. By “electrically conductive,” what is meant is that the tracks are made of a material having an electrical conductivity at 300 K higher than or equal to 1 S·cm⁻¹.

The device 1 advantageously comprises a protective layer 4 made of a dielectric, preferably a plastic, and arranged to cover the or each pair of capacitors Cᵢ^{L}, Cᵢ^{R}. By “dielectric,” what is meant is a material that has an electrical conductivity at 300 K lower than or equal to 10⁻⁶ S·cm⁻¹. By way of nonlimiting examples, the dielectric from which the protective layer 4 is made may be an epoxy resin or a silicone paste.

The device 1 advantageously comprises a ground plane GND. By “ground plane,” what is meant is any means for obtaining a reference potential for the pair or pairs of capacitors Cᵢ^{L}, Cᵢ^{R}.

The device 1 advantageously comprises control electronics 10 configured to control the or each pair of capacitors Cᵢ^{L}, Cᵢ^{R}. The control electronics 10 are electrically connected to the ground plane GND. The control electronics 10 advantageously comprise a microcontroller. The control electronics 10 advantageously comprises an electronic circuit configured to measure:

S=Σᵢ₌₁^{N}Sᵢ(z)

D=Σᵢ₌₁^{N}Dᵢ(z)

By way of non-limiting example, such measurements may be taken using the component AD7746 from the manufacturer Analog Devices, which is a capacitance-to-digital sigma-delta converter with a differential mode.

The device 1 advantageously comprises a connector 11, arranged to communicate the measurements taken by the device 1. The connector 11 may be a CAN data bus (CAN being the acronym of controller area network). According to one alternative, the control electronics 10 comprise a wireless communication module, which preferably employs one of the following technologies: BLUETOOTH®, BLUETOOTH® Low Energy, RFID, Wi-Fi, LoRa, SigFox.

### First and Second Geometric Patterns:

By way of nonlimiting examples, the electrodes of each pair of capacitors Cᵢ^{L}, Cᵢ^{R} may have a longitudinal section of rectangular shape or of chevron shape.

The first geometric patterns Cᵢ^{LB}, Cᵢ^{LT} are advantageously arranged on either side of the median axis X′-X so as to achieve an axial symmetry about the median axis X′-X. The second geometric patterns Cᵢ^{RB}, Cᵢ^{RT} are advantageously arranged on either side of the median axis X′-X so as to achieve an axial symmetry about the median axis X′-X. The first geometric patterns Cᵢ^{LT} and the second geometric patterns CRT are advantageously arranged above the median axis X′-X so as to achieve a central symmetry. The first geometric patterns Cᵢ^{LB} and the second geometric patterns Cᵢ^{RB} are advantageously arranged below the median axis X′-X so as to achieve a central symmetry.

As a result:

$${D}_{i} ( {z}_{ref} = \frac{{L}_{i}}{2} ) = {D}_{i} ( {z}_{ref} = {L}_{i} ) = K = 0$$

$${S}_{i} ( z ) ∝ z$$

The first geometric patterns Cᵢ^{LT} and the second geometric patterns CRT are advantageously arranged above the median axis X′-X so that the first and second linear electrical capacitances, integrated above the median axis X′-X in the longitudinal direction Z′-Z, possess a difference that is a constant and preferably zero. The first geometric patterns Cᵢ^{LB} and the second geometric patterns Cᵢ^{RB} are advantageously arranged below the median axis X′-X so that the first and second linear electrical capacitances, integrated below the median axis X′-X in the longitudinal direction Z′-Z, possess a difference that is a constant and preferably zero.

The first and second geometric patterns Cᵢ^{LB}, Cᵢ^{LT}; Cᵢ^{RB}, Cᵢ^{RT} are advantageously arranged so that the first and second linear electrical capacitances, integrated in the longitudinal direction Z′-Z, possess a difference that changes sign on either side of the median axis X′-X. In the case where the set of pairs of capacitors Cᵢ^{L}, Cᵢ^{R} is distributed in the longitudinal direction Z′-Z periodically with a spatial period λ, the uncertainty in the measurement of fluid height is decreased to λ/2. It is possible to carry out an inventory of the quantity of fluid with a precision of

$$\frac{1}{2 N}$$

of the total height of the device 1, where N is the number of pairs of capacitors Cᵢ^{L}, Cᵢ^{R}.

The first and second geometric patterns Cᵢ^{LB} Cᵢ^{LT}; Cᵢ^{RB}, Cᵢ^{RT} are advantageously arranged so that the first and second linear electrical capacitances, integrated in the longitudinal direction Z′-Z, possess a difference of zero for at least two reference positions of the fluid in the longitudinal direction Z′-Z.

The first and second geometric patterns Cᵢ^{LB}, Cᵢ^{LT}; Cᵢ^{RB}, Cᵢ^{RT} are advantageously arranged so that the first and second linear electrical capacitances, integrated in the longitudinal direction Z′-Z, possess a sum proportional to the position of the fluid in the longitudinal direction Z′-Z.

According to one embodiment (illustrated in FIGS. 10 and 11), the device 1 comprises a set of pairs of capacitors Cᵢ^{L}, Cᵢ^{R} distributed in the longitudinal direction Z′-Z; the first and second geometric patterns Cᵢ^{LB}, Cᵢ^{LT}; Cᵢ^{RB}, Cᵢ^{RT} of two adjacent pairs of capacitors Cᵢ^{L}, Cᵢ^{R} are advantageously arranged so that:
the sum of the first and second linear electrical capacitances, integrated in the longitudinal direction Z′-Z, is a monotonic function in the longitudinal direction Z′-Z;
the difference between the first and second linear electrical capacitances, integrated in the longitudinal direction Z′-Z, is constant in the longitudinal direction Z′-Z, and preferably zero, for the reference positions of the fluid in the longitudinal direction Z′-Z.

Thus, it is possible to encode the information of one sub-sector (i.e., a sub-sector corresponding to the spatial extent of a pair of capacitors Cᵢ^{L}, Cᵢ^{R}) with respect to an adjacent, differentiated sub-sector. The monotonic function may be a linear function; thus, a first sub-sector will possibly have an electrical capacitance denoted C₀, for a given spatial extent, and the (upper) second sub-sector will possibly have a higher electrical capacitance (equal to β C₀, β>1), for the same given spatial extent.

### Tank:

One subject of the disclosure is a tank 2 comprising at least one device 1 according to the disclosure, the or each pair of capacitors Cᵢ^{L}, Cᵢ^{R} being arranged so as to generate an electric field inside the tank 2.

The tank 2 may contain a fluid. The tank 2 may comprise a side wall 20 made of a dielectric. The dielectric is preferably a plastic or a composite. The plastic may be polyethylene. The composite may be a pre-preg, comprising a matrix (or resin) impregnating a reinforcement. The resin may be a thermosetting resin or a thermoplastic resin.

The device 1 is advantageously arranged inside the side wall 20, at distance from the fluid. The side wall 20 separates the fluid from an exterior environment. Where appropriate, the side wall 20 is hollow and comprises two portions P1, P2 forming a closed cavity. Such a hollow side wall 20 allows the device 1 to be protected from the exterior environment and from the fluid. The device 1 advantageously comprises an energy-harvesting system, arranged inside the closed cavity, and configured to harvest energy from an external source located in the exterior environment. The energy-harvesting system is electrically connected to the microcontroller of the control electronics 10. The energy is advantageously chosen from electromagnetic energy, mechanical energy and thermal energy. By way of nonlimiting examples, the external source may be an induction generator, a thermoelectrical generator, or a piezoelectrical system. The external source may emit radio waves. Where appropriate, the external source is advantageously selected from:
a smartphone fitted with an NFC module (NFC being the acronym of near-field communication),
an antenna emitting a BLE signal (BLE being the acronym of BLUETOOTH® Low Energy), or a Wi-Fi signal at 2.4 GHz or at 5 GHz.

The device 1 advantageously comprises, arranged inside the closed cavity, storage means for storing the energy harvested by the energy-harvesting system. By way of nonlimiting examples, the storage means may comprise a battery or an (e.g., carbon-based) supercapacitor.

According to one alternative illustrated in FIG. 12, the device 1 may be arranged on the exterior of the side wall 20. The device 1 may be fastened to the exterior of the side wall by adhesive bonding or by thermoforming.

The tank 2 may comprise a heating device 5, arranged in the tank 2 to heat the fluid. The heating device 5 may comprise a metal portion (for example, made of stainless steel) forming a ground. The or each pair of capacitors Cᵢ^{L}, Cᵢ^{R} is advantageously electrically connected to the ground. Setting the fluid and the control electronics 10 to a common potential allows measurements of fluid height to be obtained through a thick side wall 20, via measurement of the electrical capacitances using a three-wire method.

The device 1 for taking capacitive measurements is advantageously arranged at a distance from the fluid comprised between 0.05 mm and 25 mm, and preferably comprised between 4 mm and 6 mm.

It is possible, on the basis of the measurements of S and D taken by the electronic circuit of the control electronics 10, to compute an effective dielectric constant including the side wall 20 and the fluid facing the corresponding sub-sector (i.e., the spatial extent of the pair of capacitors Cᵢ^{L}, Cᵢ^{R} facing the fluid), so that each sub-sector possesses its own calibration law. Thus, it is possible to:
correct for variations in the thickness of the side wall 20 of the tank 2 for a given fluid,
to adapt the sensitivity of each sub-sector to variations in the properties of the fluid.

Such a self-calibration will be, in particular, made possible insofar as the level of the fluid will probably vary, and insofar as the various values associated with fixed points will be able to be deduced and stored. Such values form calibration points that allow the device 1 to be calibrated dynamically, for example using a Levenberg-Marcquardt algorithm, in order to model using a simple law the relationship between the height of the fluid and the measured electrical capacitance. An artificial-intelligence algorithm, based on machine learning, will possibly usefully complement this first approach.

### Manufacturing Process:

When the dielectric of the side wall 20 of the tank 2 is a thermoplastic, the side wall 20 may be formed using an extrusion-blow-molding process. The device 1 is added to the mold (insert) before the blowing phase. The inserts may be added to the blow mold by robots at a rate that does not slow down the cycle of molding the tank 2.

According to one alternative, the side wall 20 of the tank 2 may be formed using an injection-blow-molding process. It is possible to use a holder (the external portion P2 of the wall) to hold the device 1 in the blow mold.

According to another alternative, the side wall 20 of the tank 2 may be formed by a rotational molding process in which the device 1 is held in the mold using a medium such as a fabric or a grille, the medium preferably being made of metal.

### Results:

One example of the result of measurement is illustrated in FIGS. 14 and 15. The device 1 is integrated into the interior of a side wall 20 of the tank 2, of a thickness of the order of 5 mm. The fluid is the liquid ADBLUE®. It may be seen that the electrical capacitances of the first and second capacitors (left capacitance C^{L} and right capacitance C^{R}) decrease with the height of the liquid, the total dynamic decrease being of the order of 8 pF from 29 pF, this being largely sufficient for a precise measurement, while the amplitude of the maximum difference |C^{L}−C^{R}| is of the order of 0.45 pF, and may be adapted via the geometry of the electrodes. It may be seen in FIG. 15 that D=Σᵢ₌₁^{N} Dᵢ(z) is indeed zero for the half-periods. Since the zeros of D are multiple, it is advantageous to know at least approximately the dielectric properties of the fluid. By way of indication, if the height of the device 1 is made up of N sub-periods of the same length, the device 1 will possess of the order of 2N+1 zeros, and the dielectric properties will be advantageously known to typically better than

$$\frac{100}{2 N + 1} \%$$

to remove any indeterminacy in each discrete level.

The invention is not limited to the embodiments disclosed. A person skilled in the art has the ability to consider technically operative combinations thereof and to substitute them for equivalents.

1. A device for taking capacitive measurements of a height of a fluid in a tank, the fluid possessing a free surface, the device comprising at least one pair of capacitors extending in a longitudinal direction intended to be parallel to the normal to the free surface of the fluid, said at least one pair of capacitors comprising:
a first capacitor, comprising a first pair of electrodes forming first geometric patterns defining a first linear electrical capacitance that varies in the longitudinal direction;
a second capacitor, opposite to the first capacitor, and comprising a second pair of electrodes forming second geometric patterns defining a second linear electrical capacitance that varies in the longitudinal direction;
wherein the first and second geometric patterns are arranged so that:
the first and second linear electrical capacitances, integrated in the longitudinal direction, possess a sum that depends on the position of the fluid in the longitudinal direction;
the first and second linear electrical capacitances, integrated in the longitudinal direction, possess a difference that is a constant for reference positions of the fluid in the longitudinal direction.

2. The device as claimed in claim 1, wherein said at least one pair of capacitors comprises a median axis extending in a direction perpendicular to the longitudinal direction.

3. The device as claimed in claim 2, wherein the first geometric patterns are arranged on either side of the median axis so as to achieve an axial symmetry about the median axis; and the second geometric patterns are arranged on either side of the median axis so as to achieve an axial symmetry about the median axis.

4. The device as claimed in claim 3, wherein the first geometric patterns and the second geometric patterns are arranged above the median axis so as to achieve a central symmetry; and the first geometric patterns and the second geometric patterns are arranged below the median axis so as to achieve a central symmetry.

5. The device as claimed in claim 2, wherein the first geometric patterns and the second geometric patterns are arranged above the median axis so that the first and second linear electrical capacitances, integrated above the median axis in the longitudinal direction, possess a difference that is a constant; and the first geometric patterns and the second geometric patterns are arranged below the median axis so that the first and second linear electrical capacitances, integrated below the median axis in the longitudinal direction, possess a difference that is a constant.

6. The device as claimed in claim 2, wherein the first and second geometric patterns are arranged so that the first and second linear electrical capacitances, integrated in the longitudinal direction, possess a difference that changes sign on either side of the median axis.

7. The device as claimed in claim 1, wherein the first and second geometric patterns are arranged so that the first and second linear electrical capacitances, integrated in the longitudinal direction, possess a zero difference for at least two reference positions of the fluid in the longitudinal direction.

8. The device as claimed in claim 1, wherein the first and second geometric patterns are arranged so that the first and second linear electrical capacitances, integrated in the longitudinal direction, possess a sum proportional to the position of the fluid in the longitudinal direction.

9. The device as claimed in claim 1, wherein the first and second capacitors are capacitors with interdigitated electrodes.

10. The device as claimed in claim 1, comprising a set of pairs of capacitors, each pair of capacitors possessing a length in the longitudinal direction, the set of pairs of capacitors being distributed in the longitudinal direction so that their length follows a geometric series.

11. The device as claimed in claim 1, comprising a set of pairs of capacitors distributed in the longitudinal direction periodically.

12. The device as claimed in claim 1, comprising a set of pairs of capacitors distributed in the longitudinal direction, the first and second geometric patterns of two adjacent pairs of capacitors being arranged so that:
the sum of the first and second linear electrical capacitances, integrated in the longitudinal direction, is a monotonic function in the longitudinal direction;
the difference between the first and second linear electrical capacitances, integrated in the longitudinal direction, is constant in the longitudinal direction, for the reference positions of the fluid in the longitudinal direction.

13. The device as claimed in claim 1, comprising a protective layer made of a dielectric, and arranged to cover said at least one pair of capacitors.

14. The device as claimed in claim 1, comprising:
a printed circuit board,
electrically conductive tracks, arranged on the printed circuit board, and forming said at least one pair of capacitors.

15. A tank, comprising at least one device as claimed in claim 1, said at least one pair of capacitors being arranged so as to generate an electric field inside the tank.

16. The tank as claimed in claim 15, containing a fluid, and comprising a side wall made of a dielectric, the device being arranged inside the side wall, at distance from the fluid.

17. The tank as claimed in claim 16, comprising a heating device arranged in the tank to heat the fluid, the heating device comprising a metal portion forming a ground, said at least one pair of capacitors being electrically connected to the ground.

18. The tank as claimed in claim 16, wherein the device is arranged at a distance from the fluid comprised between 0.05 mm and 25 mm.
